(19) United States
(12) Patent Application Publication
(10) Pub. No.: US 2007/0148084 A1
(43) Pub. Date: Jun. 28, 2007

(54) Concentrating catalytic hydrogen production system

(75) Inventors: Rakesh Radhakrishnan, Vernon, CT (US); Thomas H. Vanderspurt, Glastonbury, CT (US); Joseph J. Sangiovanni, West Suffield, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation

(21) Appl. No.: 11/315,651

(22) Filed: Dec. 22, 2005

(51) Int. Cl. C01B 3/02

(52) U.S. Cl. 423/648.1; 48/61

(57) ABSTRACT

A solar-powered hydrogen production system directly produces hydrogen. The solar-powered hydrogen production system includes at least one concentrator, a hydrogen-rich source, a catalytic layer, and a hydrogen separation membrane. The hydrogen-rich source is positioned to receive focused sunlight collected by the concentrator and is in direct contact with the catalytic layer. The catalytic layer produces hydrogen from the hydrogen-rich source. The hydrogen separation membrane subsequently separates the hydrogen produced at the catalytic layer.

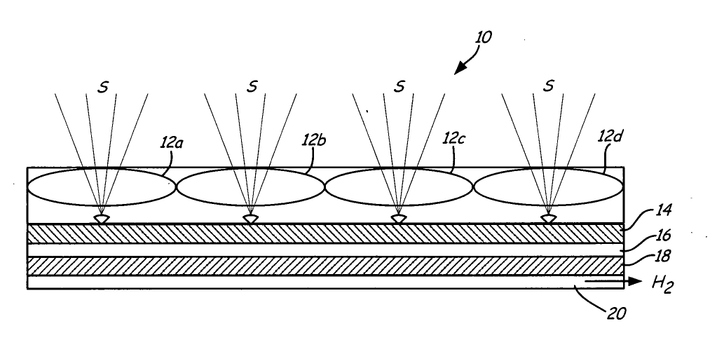

### BACKGROUND OF THE INVENTION

Photochemical and photoelectrochemical cells have the ability to extract energy from sunlight. This solar energy can be used for direct hydrogen production upon converting the solar energy into chemical energy by exciting atoms or molecules and making them more reactive, typically by producing free radicals. Made up of a semiconducting electrode (or photoanode) and a metal cathode immersed in an electrolyte, when light hits the cell, a portion of the light falling within a specified range of the electromagnetic spectrum is absorbed into the semiconductor material so that the energy of the light is transferred to the semiconductor. Upon absorption of the light, the cell generates energy, which is then used for the electrolysis of water, or other hydrogen-rich source. In the example of water, the water is oxidized by reacting with free holes (2h⁺) at the electrode to produce hydrogen (H⁺) ions and oxygen, as shown by the following reaction:
2h⁺+H₂O=½O_{2(gas)}+2H⁺_{(aq)}
The H⁺ ions are then reduced to hydrogen by electrons at the cathode to produce hydrogen, as shown by the following reaction:
2e⁻+2H⁺_{(aq)}=H_{2(gas)}

Current state of the art photoelectrochemical and photochemical systems are less than 10 percent efficient in producing hydrogen from absorbed light. A photoelectrochemical or photochemical system that can increase the hydrogen production conversion efficiency rate to approximately 30% would be a viable and cost effective alternative to current hydrocarbon fuel processing systems that emit green house gases during hydrogen production. Because solar cells can produce usable energy using a non-polluting renewable energy resource, photoelectrochemical and photochemical cell systems have become a focus in the area of hydrogen production.

### BRIEF SUMMARY OF THE INVENTION

A solar-powered hydrogen production system directly produces hydrogen. The solar-powered hydrogen production system includes at least one concentrator, a hydrogen-rich source, a catalytic layer, and a hydrogen separation membrane. The hydrogen-rich source is positioned to receive focused sunlight collected by the concentrator and is in direct contact with the catalytic layer. The catalytic layer produces hydrogen from the hydrogen-rich source. The hydrogen separation membrane subsequently separates the hydrogen produced at the catalytic layer.

### BRIEF DESCRIPTION OF THE DRAWINGS

The figure is a schematic diagram of an embodiment of a concentrating catalytic hydrogen production system having a catalytic layer.

### DETAILED DESCRIPTION

The sole figure represents a schematic diagram of concentrating catalytic hydrogen production system 10 that includes concentrators 12a, 12b, 12c, and 12d, catalytic layer 14, hydrogen-rich layer 16, hydrogen separation membrane 18, and hydrogen outlet 20. Hydrogen production system 10 uses solar energy captured from concentrators 12a-12d to produce hydrogen. Concentrators 12a-12d direct sunlight S to catalytic layer 14 which produces hydrogen from hydrogen-rich layer 16. Hydrogen production system 10 provides high hydrogen generation rates while being an environmentally friendly alternative to fuel processing systems that emit green house gases during the production of hydrogen.

In operation, concentrators 12a-12d are aligned normal to the direction of incident sunlight in order to capture the maximum amount of light rays from the sun. Concentrators 12a-12d are typically positioned directly above catalytic layer 14 and have non-imaging optics that focus a high energy density beam from sunlight S collected through concentrators 12a-12d to catalytic layer 14. The optical design of concentrators 12a-12d can be either reflective or refractive optics that concentrate the solar energy collected from the sunlight to achieve a concentration ratio of between one sun and ten thousand suns. Additionally, concentrators 12a-12d may comprise optical filter materials to filter out wavelengths based on the light absorption properties of catalytic layer 16. Although the figure depicts hydrogen production system 10 with four concentrators 12a-12d, hydrogen production system 10 may include as many concentrators as necessary to produce the desired amount of hydrogen needed at a specific site.

The light collected by concentrators 12a-12d penetrate into catalytic layer 14, which is in direct contact with hydrogen-rich layer 16. Catalytic layer 14 can be a photocatalyst, a thermocatalyst, or a combination of both that is comprised of a multijunction photoelectrochemical or photochemical cell capable of capturing and converting a broad range of wavelengths to electrical or thermal energy, respectively. The solar energy collected in the form of light and heat facilitates the photochemical and/or thermochemical reactions, or a combination of both, necessary to convert the components in hydrogen-rich layer 16 to hydrogen. Hydrogen-rich layer 16 can be any source containing hydrogen, such as water or fuel. The light absorption properties of catalytic layer 14 can optionally be tuned or enhanced using organic dyes, semiconductors, quantum dots, metal oxides, metals, and the like. In one embodiment, catalytic layer 14 is titanium dioxide.

Once the components in hydrogen-rich layer 16 have been reacted and the hydrogen has been split from the other secondary components, hydrogen separation membrane 18 separates the hydrogen from the secondary components. Hydrogen separation membrane 18 can be formed of various membrane materials, including, but not limited to: inorganic membranes, organic membranes, ceramic-based membranes, silica-based membranes on ceramic or metal supports, palladium membranes, or a membrane that is a binary, ternary, or quaternary combination of palladium and other metals. After the hydrogen has been separated from the secondary components from hydrogen separation membrane 18, the hydrogen is transported by hydrogen outlet 20 to an external source for use. For example, the hydrogen can be sent to an engine or a fuel cell to generate electricity.

The catalytic hydrogen production system is set up as a flow system that produces hydrogen while simultaneously separating hydrogen from secondary components using a hydrogen separation membrane. The hydrogen production system generally includes a plurality of portable concentrators that capture and focus a high density energy beam of light to a catalytic layer, such as a photoelectrochemical or photochemical cell, that is in direct contact with a hydrogen-rich source. The catalytic layer splits the hydrogen from secondary components in the hydrogen-rich source. A hydrogen separation membrane then separates the hydrogen from the secondary components for direct hydrogen production. The hydrogen can subsequently be used as fuel.

Although the present invention has been described with reference to preferred embodiments, workers skilled in the art will recognize that changes may be made in form and detail without departing from the spirit and scope of the invention.

1. A solar-powered hydrogen production system, the system comprising:
at least one concentrator for collecting and focusing sunlight;
a hydrogen-rich source positioned to receive the sunlight collected by the concentrator;
a catalytic layer in direct contact with the hydrogen-rich source for producing hydrogen; and
a hydrogen separation membrane for separating the hydrogen produced at the catalytic layer.

2. The hydrogen production system of claim 1, and further comprising a plurality of concentrators.

3. The hydrogen production system of claim 1, wherein the catalytic layer comprises a photocatalyst.

4. The hydrogen production system of claim 1, wherein the catalytic layer comprises a thermocatalyst.

5. The hydrogen production system of claim 1, wherein the catalytic layer comprises a photoelectrochemical cell.

6. The hydrogen production system of claim 1, wherein the catalytic layer comprises a photochemical cell.

7. The hydrogen production system of claim 1, wherein the hydrogen separation membrane separates the hydrogen from secondary components in the hydrogen-rich source.

8. A concentrated solar catalytic hydrogen production system for direct production of hydrogen from a hydrogen-rich source, the system comprising:
at least one optical element for concentrating sunlight;
a catalytic cell positioned to receive concentrated sunlight from the optic lens; and
a hydrogen separation device for separating hydrogen from secondary components produced in the catalytic cell.

9. The hydrogen production system of claim 8, wherein the optical element is a concentrator for focusing sunlight into a high density energy beam.

10. The hydrogen production system of claim 8, and further comprising a plurality of optical elements.

11. The hydrogen production system of claim 8, wherein the catalytic cell comprises a photocatalyst, a thermocatalyst, or a combination thereof.

12. The hydrogen production system of claim 8, wherein the catalytic cell comprises a photoelectrochemical cell.

13. The hydrogen production system of claim 8, wherein the catalytic cell comprises a photochemical cell.

14. The hydrogen production system of claim 8, wherein the hydrogen separation device is a hydrogen separation membrane.

15. A method for directly producing hydrogen using solar energy, the method comprising:
capturing sunlight with a plurality of concentrators;
directing the captured sunlight to a catalytic layer and through a hydrogen source to produce hydrogen and secondary components; and
separating the hydrogen from the secondary components.

16. The method of claim 15, wherein capturing sunlight with a plurality of concentrators comprises using concentrators having non-imaging optics.

17. The method of claim 15, wherein directing the captured sunlight comprises focusing a high energy density beam onto the catalyic layer.

18. The method of claim 15, wherein the catalytic layer is a photoelectrochemical cell or a photochemical cell.

19. The method of claim 15, wherein the catalytic layer comprises a photocatalyst, a thermocatalyst, or a combination thereof.

20. The method of claim 15, wherein separating the hydrogen from the secondary components comprises using a hydrogen separation membrane.
